(19) United States
(12) Patent Application Publication
(10) Pub. No.: US 2021/0019798 A1
(43) Pub. Date: Jan. 21, 2021

(54) METHOD FOR SIMULTANEOUS SENDING OF DISCOUNT REQUESTS TO MULTIPLE SUPPLIERS ON AN ELECTRONIC PLATFORM OF AN AGGREGATOR OF GOODS

(71) Applicant: Valery KARDANOV, Lilienthal (DE)

(72) Inventor: Valery KARDANOV, Lilienthal (DE)

(21) Appl. No.: 16/328,429

(22) PCT Filed: Dec. 19, 2017
(86) PCT No.: PCT/IB2017/001768

§ 371 Date: Feb. 26, 2019

(30) Foreign Application Priority Data
Dec. 29, 2016 (RU) 2016152233

(51) Int. Cl. G06Q 30/06; G06Q 10/10

(52) U.S. Cl. CPC G06Q 30/0611; G06Q 30/0605; G06Q 30/0206; G06Q 10/107; G06Q 30/0629; G06Q 30/0641

(57) ABSTRACT

This invention relates to the field of data processing, and especially to e-commerce platforms that are online aggregators of goods. Technical result consists in expansion of the functionality of the e-platform of the online aggregator of goods. The method involves simultaneous sending of discount requests to multiple suppliers. The e-commerce platform has an e-commerce database containing information about suppliers, as well as a web-page with information about a product, suppliers of this product and the corresponding prices. In addition, there is an active web interface element for sending requests for discount. When this element is activated, the e-commerce platform can use the information about suppliers of goods and send an e-mail to all suppliers through the communications network. After receiving responses from at least one supplier, the e-commerce platform will process the information about discounts and display the discounted prices.

### CROSS-REFERENCE TO RELATED APPLICATIONS

The present patent application is a National stage patent application from PCT application PCT/IB2017/001768 filed on Dec. 19, 2017 which claims priority to Russian patent application RU 2016152233 filed on Dec. 29, 2016.

### FIELD OF INVENTION

This invention relates to the field of data processing, and especially to e-commerce platforms that are online aggregators of goods.

### GLOSSARY

CSV (Comma-Separated Values) stands for the text format used for presenting data in tabular format.

EAN (European Article Number) stands for the European bar code standard, designed to encode identifiers of products and manufacturers.

GTIN (Global Trade Item Number) stands for the international code of marking and accounting of logistics units.

ID (data name, identifier) stands for the unique feature of an object, which distinguishes it from other objects.

URL (Uniform Resource Locator) stands for the unified locator (location identifier) of the resource.

Aggregator is an e-commerce platform providing procurement “in a single step”.

Database is a collection of independent materials (articles, calculations, regulations, court decisions and other similar materials) presented in an objective form and systematized so that these materials are made available for searching and processing with the help of a personal computer (PC).

Web-based Interface is a set of tools with the help of which users interact with a website or any other application through a web browser.

Web-page is a document or an information resource in the World Wide

Web, which can be accessed through a web browser.

Checkbox is an element of the graphical user interface that allows the user to control a parameter with two possible states: [symbol] checked and [symbol] unchecked.

Cart is a temporary storage for selected items before ordering from online stores.

My Account is a set of software tools that includes the web interface and provides the user with access to his/her account.

Account is a set of user data that is stored in the computer system and used to identify (authenticate) the user and provide access to his/her personal data and settings.

E-commerce Platform is a hardware and software system consisting of organizational, informational and technical solutions to enable interaction between the seller and the buyer via e-commerce communications channels.

Interface Element is an elementary interface component that has a standard appearance and performs standard operations.

### SUMMARY

Currently, a huge e-commerce market has been formed on the Internet. There are many online stores, and the aggregated range of products is virtually unlimited. Given the number of offered goods, the buyer has the opportunity to find the right product at an affordable price. On the other hand, searching is complicated by the fact that not all online stores that offer the right product can be on the first pages of the search results generated by search engines. This situation has led to the emergence of specialized Internet platforms, on which online retailers are trying to occupy more advantageous positions, in order to more successfully sell their goods via these platforms. However, even this approach does not guarantee that a potential buyer will go to the landing page of a particular store. Firstly, large e-commerce platforms use rankings (for example, by price). Online stores with higher prices will again not be able to get to the top of the search results on these e-commerce platforms. Moreover, online stores often have no opportunity to monitor the prices of goods being sold by their competitors. That is, stores should not only make every effort to improve their ranking, but also to offer the customer an equal or lower price. There are many methods of achieving this goal on the Internet, such as cashback and promo codes. Given the large number of stores and individual proposals offering reduced prices, it is not possible for a buyer to use any objective methods to make an informed buying decision.

Modern e-commerce platforms, as well as online and physical stores should understand that a potential customer who wants to buy a particular product will buy this product only in one particular store. All other sellers are not informed about this buyer, and so they cannot enter the competition for this customer. That is, they cannot offer him/her their terms and conditions for the purchase, and thus they are deprived of any chance of selling the same product to him/her, even if their offer would be more favorable for the buyer. The submitted invention allows potential customers to send requests for discount, simultaneously to all suppliers that offer the relevant goods. Thus, all the stores that receive a request for a discount are originally on an equal footing, in terms of the possibility of closing the transaction, so the method for simultaneous sending of discount requests to multiple suppliers offers an indisputable advantage.

The closest analogue of the submitted invention is a technical solution from the US 2013191203 patent application, which allows online aggregators to provide sellers with an opportunity to offer discounts to buyers before they go to a competitor's website.

However, the said solution does not allow sending discount requests to all suppliers of a particular product at the same time.

The submitted invention is intended to solve a technical problem, which is the need to develop an e-commerce platform for an aggregator of goods, which will provide the opportunity to send discount requests to all suppliers of the relevant goods at the same time.

Technical result of the submitted invention consists in expansion of the functionality of the a-platform of the on line aggregator goods.

The method for simultaneous sending of discount requests to multiple suppliers on an e-commerce platform of an aggregator of goods allows achieving the said technical result as follows: an e-commerce platform of an aggregator of goods has an e-commerce database containing information about suppliers, as well as at least one web-page with information about the product and at least two suppliers of this product, and the corresponding prices. In addition, there is an active web interface element for sending requests for discount. By activating this element, the e-commerce platform can use information about suppliers of goods and send an e-mail to all suppliers through a communications network. After receiving responses from at least one supplier, the e-commerce platform will process the information on discounts and display the discounted prices.

The e-commerce platform can compare prices before sending requests for discount to various suppliers and display information about the supplier with the lowest price on the web-page of the corresponding product. After processing the information about discounts obtained from at least one supplier, the e-commerce platform can re-compare the prices, taking into account discounts, in order to display updated information about the supplier with the lowest price on the product's web-page.

The e-commerce platform can provide the customer with access to his/her

My Account and display information about the discounted price in the customer's My Account, after receipt of an e-mail from the supplier.

The e-commerce platform can provide the supplier with access to an individual My Account. After activating a special active element of the web interface, allowing to request discounts, the supplier of the goods of interest will receive an e-mail message. In addition, information about the request will be displayed in the supplier's My Account containing an active element of the web interface, allowing to input a discount rate.

The submitted method provides the buyer with an opportunity to send discount requests to all suppliers of the necessary goods at the same time. After that, the buyer can choose the best price. Moreover, the submitted method significantly increases the speed of shopping by allowing the buyer to get rid of the need to track discounts on third-party websites; the usability of online aggregator platform is also increased greatly. With regard to the supplier, the submitted method allows him/her to directly affect specific transactions by improving the efficiency of interaction with the buyer, and excluding intermediaries.

### BRIEF DESCRIPTION OF THE DRAWINGS

A special case of the submitted method is shown in FIGS. 1-11:

FIG. 1. Flow chart of the implemented method for sending of discount requests.

FIG. 2. Web-page of the supplier's My Account allowing to upload a CSV file.

FIG. 3. Web-page of the search engine.

FIG. 4. Web-page of the supplier's My Account.

FIG. 5. Web-page for inputting information about the supplier.

FIG. 6. Web-page containing information about the product.

FIG. 7. Web-page containing a set of active elements of the web interface.

FIG. 8. Web-page of the supplier's My Account displaying a request for discount.

FIG. 9. Web-page of the buyer's My Account displaying a countdown timer for the validity period of the discount.

FIG. 10. Web-page of the buyer's My Account displaying information about the product and discounted prices.

FIG. 11. Web-page displaying information about the product and discounted prices that was generated for the buyer who requested a discount.

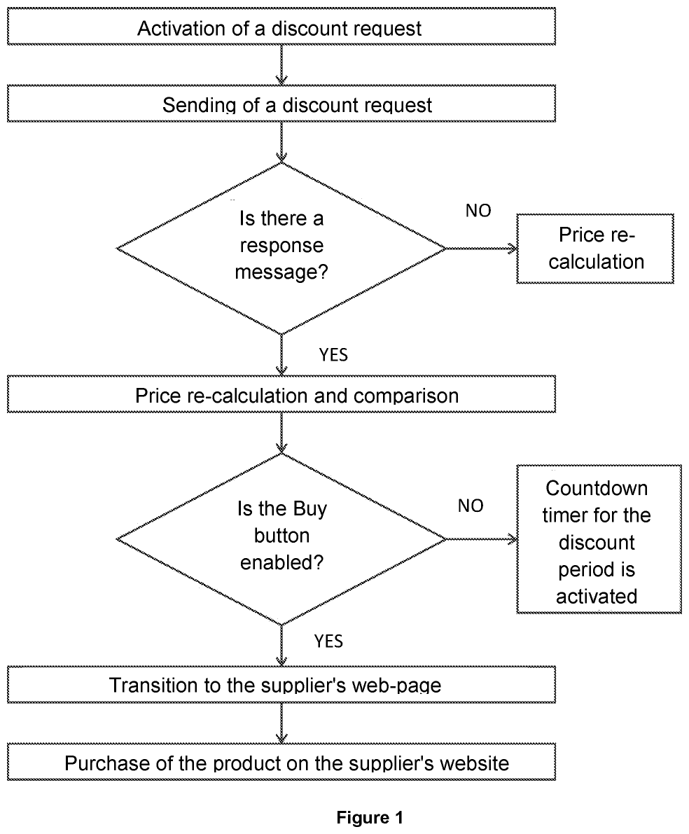

Elements 1-7 in FIGS. 1-11 are used for the following:

1 is the Choose File button;

2 is the Upload button;

3 is the active element of the web interface;

4 is the Send Discount Request button;

5 is the field allowing to input the discount rate;

6 is the Send Offer button;

7 is the Buy button.

### DETAILED DESCRIPTION OF THE PREFERED EMBODIMENT

The submitted method is implemented as follows.

Suppliers publish information about their products on an e-commerce platform of an online aggregator by uploading CSV files.

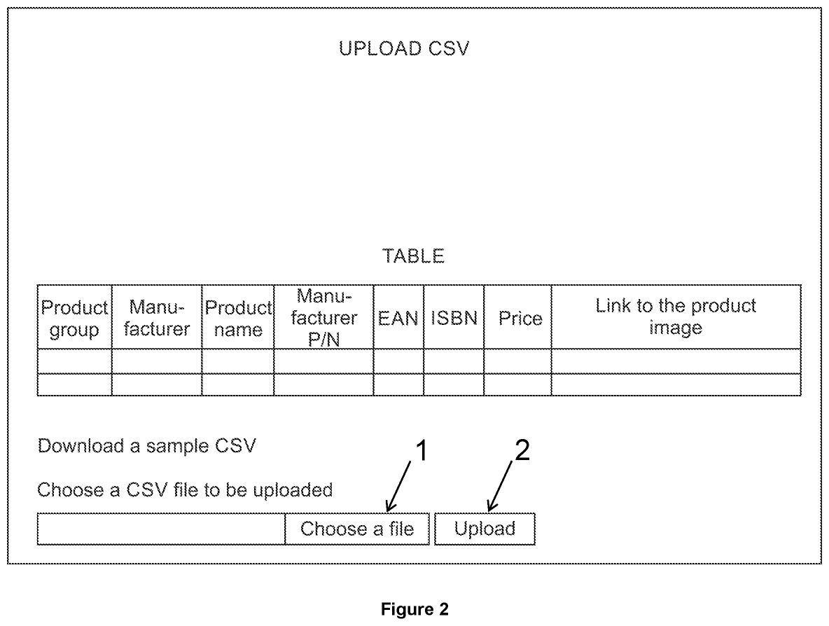

CSV files are uploaded as follows. Suppliers can upload files manually or automatically. A supplier can use his/her My Account to manually upload a CSV file by pressing the Upload CSV file (please see FIG. 2). After pressing the Choose File (1) button, the supplier can choose a file and click Upload (2). Suppliers can also use the ID and key (sekure_key) provided by the e-commerce platform, in order to set up automatic uploads of CSV files. To do this, the supplier should set up a task in the task scheduler on the server of his/her website, in order to enable automatic sending of CSV files to the server of the e-commerce platform, along with the corresponding ID and sekure_key. The POST method should be used for data transmission. Upon uploading of a CSV file, all existing products are replaced with new ones.

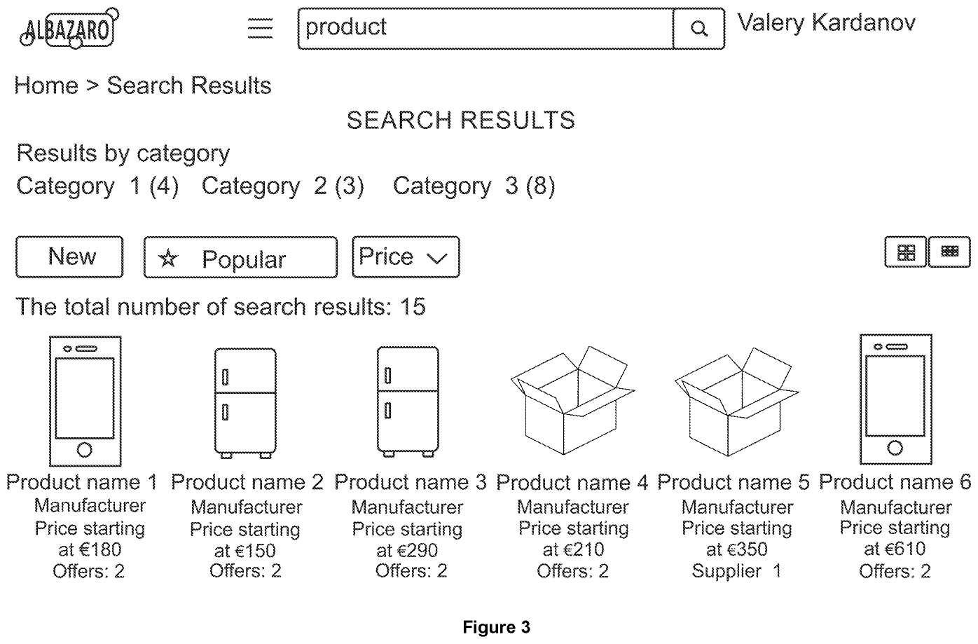

Suppliers' CSV files are used by the e-commerce platform for the grouping of identical goods by a single unique parameter (EAN/GTIN of the manufacturer or drug registration number) or a set of non-unique parameters: identical description, color, size and name of the product. The purpose of this grouping is to find the lowest price for a particular product. Web-page of the search engine allowing to find all available suppliers of a specific product is shown in FIG. 3.

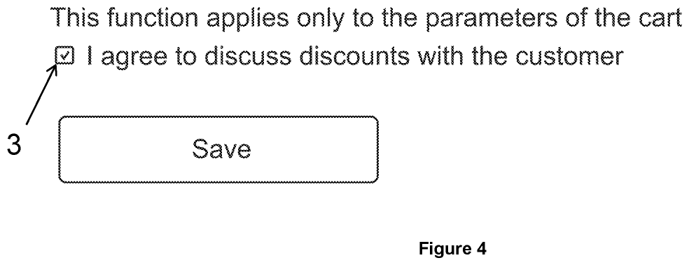

The supplier (a representative of an online store, official distributor or the seller of a particular product) should register on the e-commerce platform and indicate whether he/she wants to receive discount requests from customers. FIG. 4 shows the active interface element (3) in the form of a checkbox. After activation of this element, a special attribute will be added to the supplier's record in the database of the ecommerce platform. This attribute means that the supplier will receive e-mails about discount requests submitted by buyers. This attribute can also be activated in the supplier's My Account.

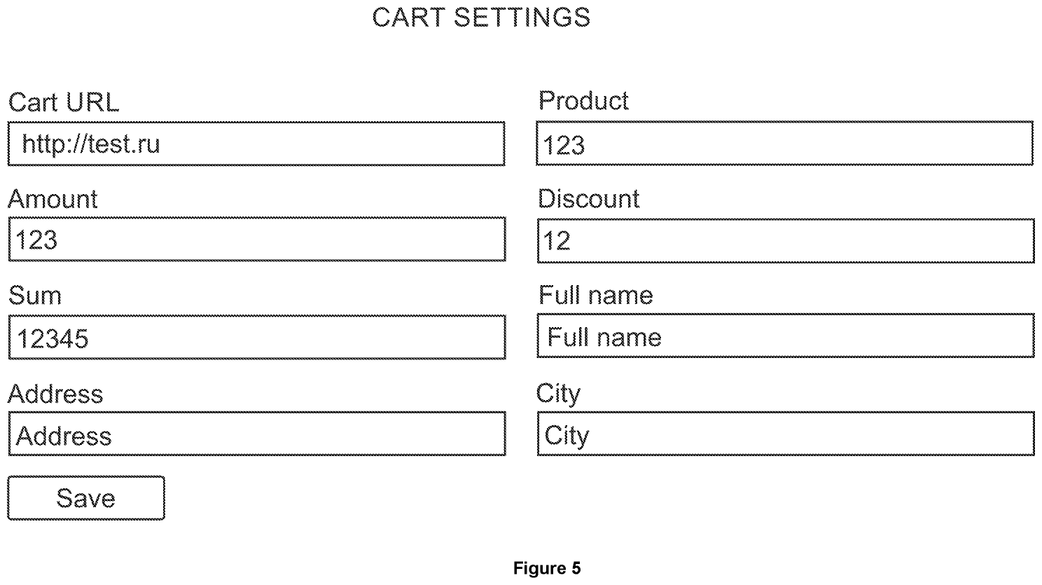

To enable the use of the method for selling goods at a discount, suppliers should provide the e-commerce platform with data about their shopping cart. The e-commerce platform extracts this information from the source code of suppliers' websites. Suppliers fill in the following fields in the Cart Settings section of My Account, or when registering on the e-commerce platform: Cart URL, Product, Amount, Sum, Discount, as well as the fields for personal data of the buyer such as Name and Address (please see FIG. 5). By providing the personal data of the buyer, the supplier relieves him/her from the necessity to enter his/her personal data on the supplier's website upon purchasing a specific product, as well as from the need to register (if the appropriate function was set up in the code of the supplier's website).

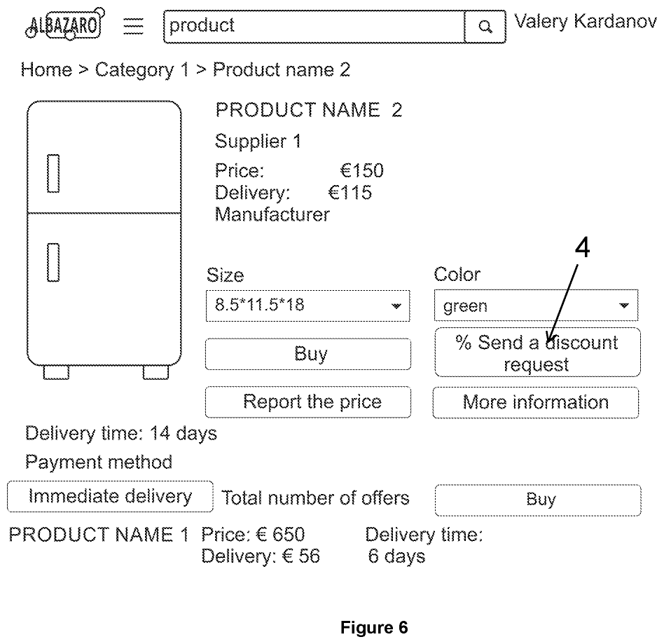

The buyer finds the desired product on the e-commerce platform, opens a webpage with information about the product and compares the prices of several suppliers (please see FIG. 6).

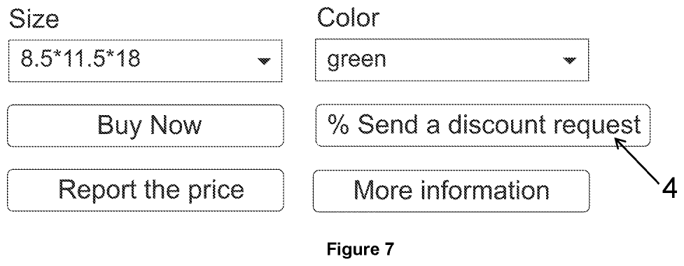

The buyer can request a discount for this product. By pressing the active element in the form of the Send Discount Request button (in this specific case, please see FIGS. 6 and 7), the buyer initiates sending a discount request to all suppliers who reported that they were able to receive such requests. The e-commerce platform sends discount requests to suppliers via e-mail or displays them in the suppliers' My Account.

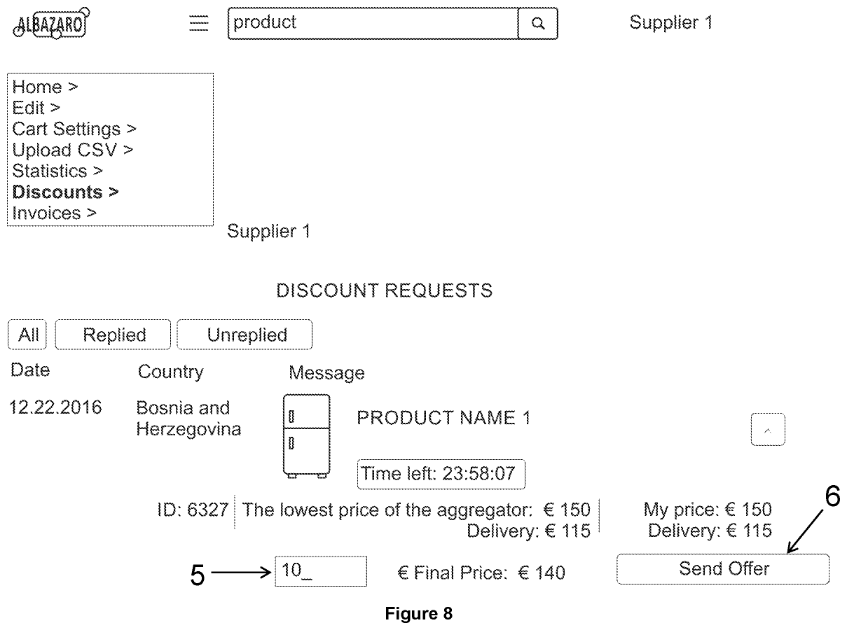

During the period determined by the administrator of the e-commerce platform (for example, 24 hours), each supplier can respond to the request and specify a discount rate. The e-commerce platform also provides the supplier with information about the lowest price from other suppliers. In the Discounts section of his/her My Account, the supplier can see discount requests for specific products and input discount rates in the corresponding field (5) (please see FIG. 8). The interface element for entering discounts can also be represented as a radio button or drop-down list containing specific values of the possible discount. The supplier should confirm his/her discount by pressing the Send Offer button (6). The e-commerce platform sends an e-mail response to the buyer via a communications channel, processes the information about the discount and calculates the discounted price.

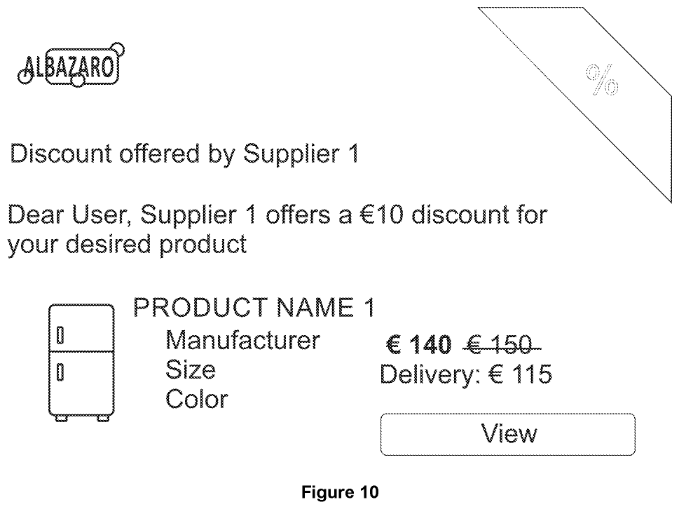

The buyer receives a notification from the e-commerce platform via e-mail and/or in his/her My Account (please see FIG. 10). This notification contains information about discounts offered by suppliers. The period of validity of each of the discounts can be limited by the administrator of the electronic platform (for example, 24 hours), and each of the suppliers' responses has its own countdown timer.

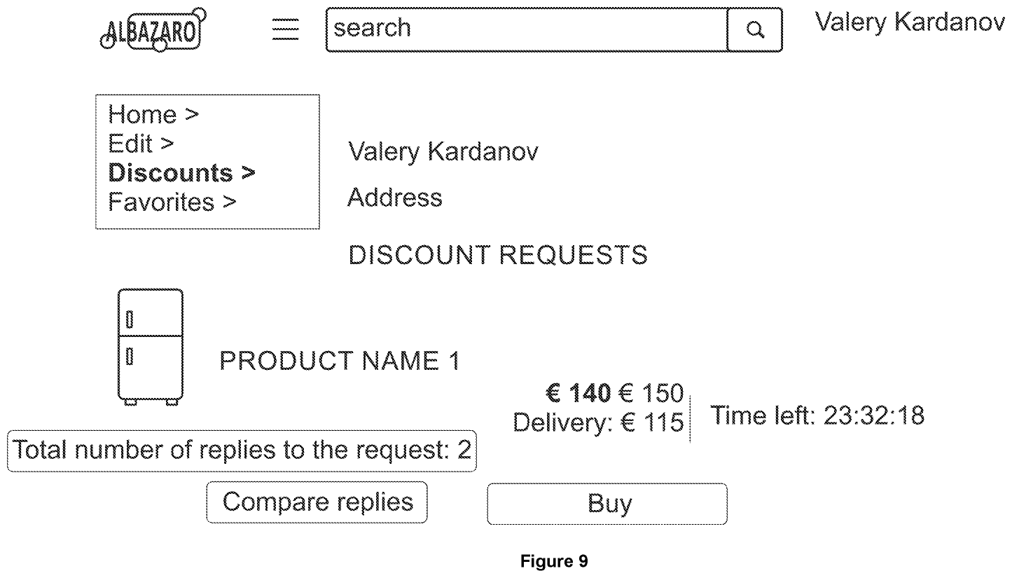

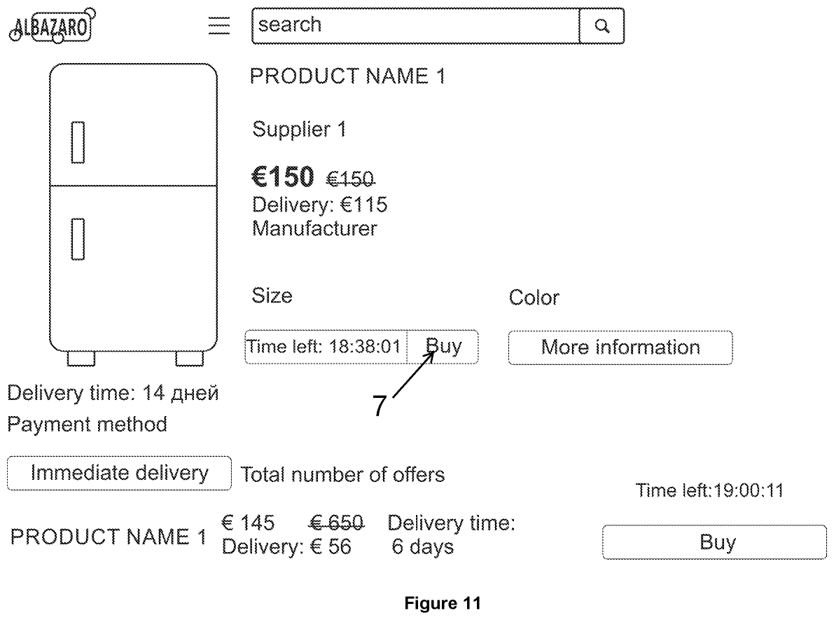

The e-commerce platform provides the buyer with information about discounted prices via e-mail or in his/her My Account. In his/her My Account, the buyer can compare discounted prices for the desired product. Products for which a discount was requested are displayed in the Discounts section (please see FIG. 9). In this specific case, when the Compare Responses button is pressed, the e-commerce platform generates a unique web-page for this product (please see FIG. 11), taking into account all effective prices (discounted and not discounted) and displays the lowest price. Thus, the buyer gets the desired product at the lowest price, thanks to comparison of all effective prices after receiving responses to discount requests.

The buyer chooses the best deal on the page with discounts and presses the

Buy button (7).

After pressing the Buy button (7), the platform opens a new browser window and displays a web-page of the shopping cart using the URL provided by the supplier. The e-commerce platform transmits a data set to the cart containing the following parameters for the selected product: price, discount rate, amount. Personal data of the user can also be transferred in order to relieve the buyer from having to register on the supplier's website: first name, last name, delivery address (the user should first enter these data in his/her My Account).

The next step involves the signing of a purchase agreement between the supplier and the buyer, in accordance with the supplier's terms and conditions.

The submitted invention allows a single e-commerce platform to provide customers with access to various offerings from various suppliers, and the ability to further reduce the price by sending discount requests to all suppliers of the relevant goods at the same time.

These examples are special cases, and do not demonstrate all possible implementations of the submitted invention.

Professionals in this field should understand that variations of the submitted method do not change the essence of the submitted invention; instead, they simply define its specific implementations.

What we claims is:

1. A method for simultaneous sending of discount requests to multiple suppliers on an e-commerce platform of an aggregator of goods, comprising:
the e-commerce platform of the aggregator of goods has an e-commerce database containing information about the suppliers, as well as at least one webpage with information about a product and at least two suppliers of this product and corresponding prices;
there is an active web interface element for sending the requests for the discount;
when this element is activated, the e-commerce platform can use the information about suppliers of goods and send an e-mail to all suppliers through a communications network;
after receiving responses from at least one supplier, the e-commerce platform will process the information about discounts and display the discounted prices.

2. The method according to claim 1, wherein:
the e-commerce platform compares prices before sending the requests for the discount to the various suppliers and displays the information about the supplier with a lowest price on the web-page of the corresponding product;
after processing the information about the discounts, obtained from at least one supplier, the e-commerce platform re-compares the prices, taking into account the discounts, in order to display an updated information about the supplier with the lowest price on the product's web-page.

3. The method according to claim 1, wherein:
the e-commerce platform provides the customer with access to a his/her My Account and the displays information about the discounted price in the customer's My Account, after receipt of an e-mail from the supplier.

4. The method according to claim 1, wherein
the e-commerce platform provides the supplier with access to an individual My Account;
after activating a special active element of the web interface, allowing to request the discounts, the supplier of the goods of interest will receive an e-mail message;
information about the request will be displayed in the supplier's My Account, containing an active element of the web interface allowing to input a discount rate.
